(19) United States
(12) Patent Application Publication
(10) Pub. No.: US 2016/0069388 A1
(43) Pub. Date: Mar. 10, 2016

(54) THRUST RING AND METHOD OF MANUFACTURING OR REFURBISHING A THRUST RING

(71) Applicant: Caterpillar Inc., Peoria, IL (US)

(72) Inventors: ROBERT SHARP, CORINTH, MS (US); JEREMIAH KELTNER, CORINTH, MS (US)

(73) Assignee: Caterpillar Inc., Peoria, IL (US)

(21) Appl. No.: 14/481,361

(22) Filed: Sep. 9, 2014

(51) Int. Cl. F16C 33/06

(52) U.S. Cl. CPC F16C 33/06

(57) ABSTRACT

A thrust ring is provided that includes: an annularly shaped body defining an interior hole having a diameter; an annularly shaped insert defining an exterior diameter sized similarly to the interior hole diameter; a top surface located on the body, the top surface located adjacent to the interior hole; and an insert surface defined by the insert, the insert surface being annularly shaped; and an interior chamfered surface on the insert intersecting the insert surface. A method of making a thrust ring is provided. The method includes: forming an insert pocket, the insert pocket having an interior diameter in an annular body; forming an annular insert to have an outer diameter slightly larger than the interior diameter of the insert pocket; cooling the insert; and pressing the insert into the insert pocket.

### TECHNICAL FIELD

The present disclosure relates generally to a thrust ring for a hydraulic hammer. More particularly, the present disclosure relates to manufacturing and/or refurbishing a thrust ring.

### BACKGROUND

Hydraulic impact hammers are heavy equipment used in mining, construction, demolition, roadwork, quarrying, and similar applications. These hammers are used to break up concrete, rock, ore, and the like. They are also sometimes used to remove surface portions from an underlying substrate.

Hydraulic impact hammers generally comprise a housing having a central cylinder. A piston is contained within the cylinder. The top end of the cylinder communicates with or forms part of a gas chamber. The bottom end of the cylinder communicates with a bore in a tool holder which is connected to the housing. The tool holder contains a tool, such as a chisel point, which will strike an object the tool is contacting such as concrete, rock, ore or whatever is being worked by the hammer. The hydraulic fluid forces the piston up compressing the gas in the gas chamber. When the piston reaches a certain height, the hydraulic fluid is allowed to exit the portion of the cylinder below a piston seal and the piston is brought down forcefully to strike the tool. The tool is thus sharply hammered and, in turn, impacts upon the object desired to be impacted. The piston reciprocates rapidly resulting in numerous forceful blows against the tool.

One feature developed to compensate for the difficult environment described and the intrusion of particles into the lower end of the hammer is the use of a thrust ring. The tool holder, holding the tool in place at the bottom of the hammer does not bear directly against the tool. Rather, a cylindrical thrust ring is fitted into a recess in the bottom end of the tool holder and surrounds the tool. The tool moves within the thrust ring. Wear occurs between the tool and the tool thrust ring. The operator may periodically check the tool and thrust ring for wear, or at regular intervals, the hammer will be disassembled and overhauled. During overhauls, is typically normal to replace the thrust ring. It can be expensive to repeatedly be replacing the thrust ring, particularly when only portions of the thrust ring exhibit signs of wear.

One patent, U.S. Pat. No. 6,510,904 describes an input bushing for a heavy-duty hydraulic hammer. This patent describes a polymeric bushing protected by a steel ring below the polymeric bushing to prevent foreign objects from impacting on the polymeric bushing. However, the steel ring insert is designed to protect the polymeric bushing from foreign objects from impacting the polymeric bushing and the ring and bushing are made of different materials, rather than wear from the tool and/or piston.

Accordingly, it is desirable to provide a method and apparatus that allows for a thrust ring to be refurbished when worn in order to avoid the waste of getting rid of an entire thrust ring when only a portion of the thrust bearing exhibits signs of wear.

### SUMMARY

The present disclosure provides a thrust ring that includes: an annularly shaped body defining an interior hole having a diameter; an annularly shaped insert defining an exterior diameter sized similarly to the interior hole diameter; a top surface located on the body, the top surface located adjacent to the interior hole; an insert surface defined by the insert, the insert surface being annularly shaped; and an interior chamfered surface on the insert intersecting the insert surface.

The present disclosure also describes, an insert for a thrust ring includes: an annularly shaped body defining an interior hole having a longitudinal axis; an insert surface defined by the body and located at one end of the body; an underside surface located at an opposite end of the body than the insert surface, the underside surface being more narrow than the insert surface; a ring shaped portion located in an interior of the insert, the ring shaped portion defines a cross-section of the interior hole taken parallel to the longitudinal axis, and the ring shaped portion defines converging and diverging surfaces; and a chamfered surface located on the insert surface and the chamfered surface encompasses the interior hole.

The present disclosure also describes, a method of making a thrust ring is provided. The method includes: forming an insert pocket, the insert pocket having an interior diameter in an annular body; forming an annular insert to have an outer diameter slightly larger than the interior diameter of the insert pocket; cooling the insert; and pressing the insert into the insert pocket.

### BRIEF DESCRIPTION OF THE DRAWINGS

FIG. 1 is a view illustrating a machine equipped with a hydraulic hammer according to a preferred embodiment of the invention.

FIG. 2 is an isometric, cross-sectional view of a hydraulic hammer including a thrust ring.

FIG. 3 is a isometric view of a thrust ring.

FIG. 4 is a bottom, isometric view of an insert for the thrust ring.

FIG. 5 is a cross-sectional view of a thrust ring configured to accept an insert and the insert is installed in the thrust ring.

FIG. 6 is a top view of an insert installed in a thrust ring.

FIG. 7 is a side view of an insert installed in a thrust ring.

FIG. 8 is a flowchart illustrating steps for installing an insert in a thrust ring.

### DETAILED DESCRIPTION

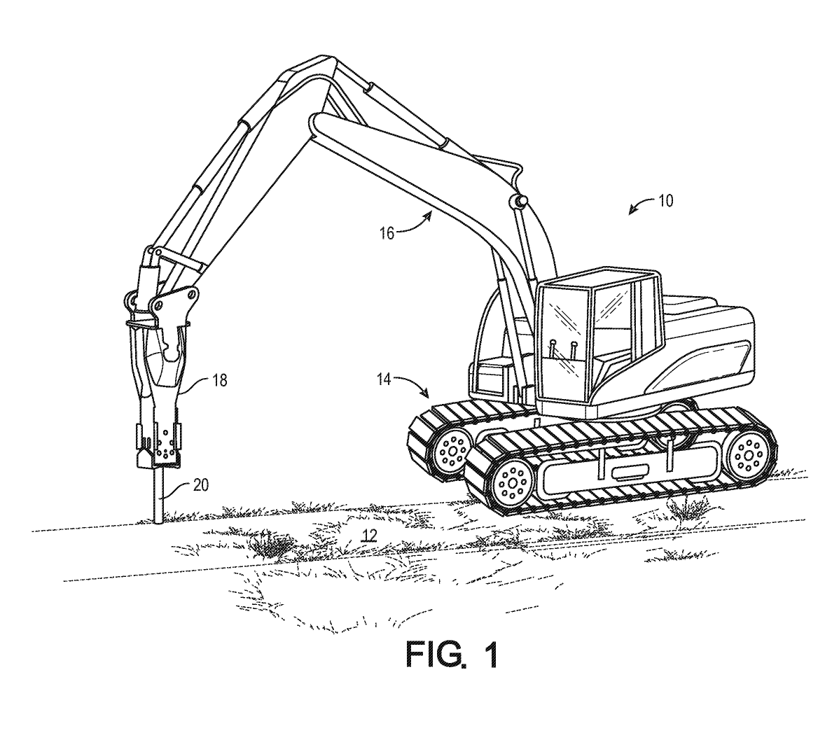

The invention will now be described with reference to the drawing figures, in which like reference numerals refer to like parts throughout. An embodiment in accordance with the present invention provides a machine 10 set upon the ground 12. The machine 10 includes moving elements 14 which, as shown in FIG. 1 are tracks 14. In other embodiments, other moving elements such as wheels or any other suitable moving elements 14 may also be used.

The machine 10 may include an actuator arm 16. A hammer 18 such as, for example a hydraulic hammer 18, is mounted to the end of the arm 16. The hammer 18 actuates a tool bit 20 which may rapidly move up and down in order to pound and/or chisel the various objects such as rock, concrete, pavement, or other objects desired to be fractured. The machine 10 may be an excavator 10, as shown, or any other type of machine 10 adaptable to actuating and controlling a hammer 18.

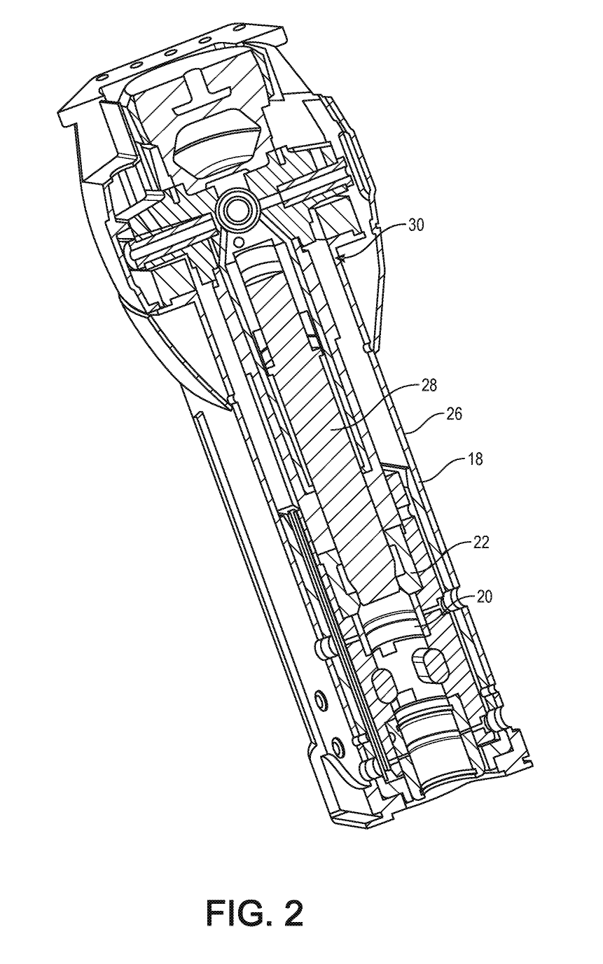

FIG. 2 is a partial cross-sectional view of a hammer 18 such as the one illustrated in FIG. 1. The hammer 18 includes a hammer housing 26 which houses a piston 28. The piston 28 may be hydraulically (or otherwise) actuated to strike the tool bit 20 through the thrust ring 22. The striking of the tool bit 20 by the piston 28 causes the tool bit 20 to move up and down and provides a pounding motion the tool bit 20 imparts upon an object such as a rock, concrete, pavement, or any other substance desired to be pounded.

The hammer housing 26 may also protect other internal parts to the hammer 18 which are either well known or not relevant to the present disclosure. As result, the other elements 30 will not be discussed further.

As would be apparent to one of ordinary skill in the art after reviewing this disclosure, the thrust ring 22 receives a tremendous amount of repeated force. As result, over time, the thrust ring 22 may exhibit signs of wear or other undesirable fatigue. From time to time it may be desirable to replace or refurbish the thrust ring 22 so that the hammer 18 will continue to operate properly and efficiently.

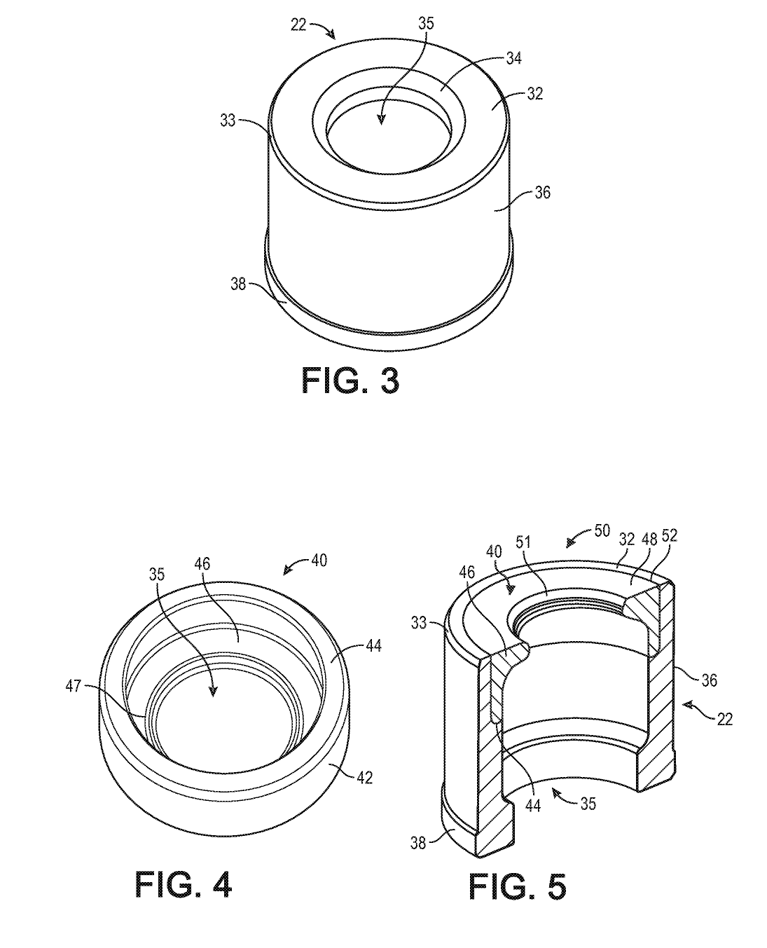

FIG. 3 illustrates a typical thrust ring 22. The thrust ring 22 includes a body 36 having an upper surface 32, an external chamfer 33 and an internal chamfer 34 encompassing a through hole 35. The body 36 may also include an exterior ridge 38. In some embodiments, the exterior ridge 38 may help to secure the thrust ring 22 in position within a hammer 18.

During use, the portions of the thrust ring 22 that experience wear include the upper surface 32 and the internal chamfer 34 located around the through hole 35. In some embodiments, rather than getting rid of the entire thrust ring 22 when it is worn, the thrust ring 22 may be refurbished. An insert 40 as shown in FIG. 4 may be prepared for insertion into the thrust ring 22.

The insert 40 may be made of the same material as the thrust ring 22. In some embodiments, the material is steel.

FIG. 4 illustrates the insert 40 viewed from the bottom. The insert 40 may include a body 40 having a side portion 42 which, in some embodiments, defines the insert 40 to be generally cylindrical. The insert 40 may include an underside surface 44, a ring shaped portion or ledge surface 46. The insert 40 may define a through hole 35 defined by the ring shaped portion or ledge 46. The ledge 46 may define a chamfered surface 47 at the through hole 35.

FIG. 5 illustrates a cross-section of a thrust ring 50 configured to receive an insert 40 and the insert 40 located in the thrust ring 50. In this disclosure, the thrust ring not yet having a receiving hole 52 is referred to by reference character 22 and a thrust ring having a receiving hole is referred to by reference character 50. In some embodiments, an existing thrust ring 22 (which may originally had been a unitary piece such as that shown in FIG. 3) may be machined or otherwise modified to include an insert receiving socket 52 (sometimes referred to as a pocket 52 or hole 52). Forming the insert receiving socket or hole 52 includes removing the chamfered surface 34 and a portion of the upper surface 32 shown in FIG. 3. The operation of forming the receiving hole 52 may be done by cutting out the hole 52 as the thrust ring 22 turns on a lathe, by drilling out the hole 52 or enlarging a portion of the through hole 35 or any other suitable way of machining or modifying the thrust ring 22.

In some embodiments, the thrust ring 50 may be originally manufactured to include the insert receiving hole 52. In such instances the body 36 of the thrust ring 50 may have the insert receiving hole 52 manufactured into the body 36 during the original fabrication of the thrust ring 50 rather than forming the insert receiving hole 52 and an existing thrust ring 22 as is done in cases of refurbishment of thrust rings 22 not yet having a socket or hole 52.

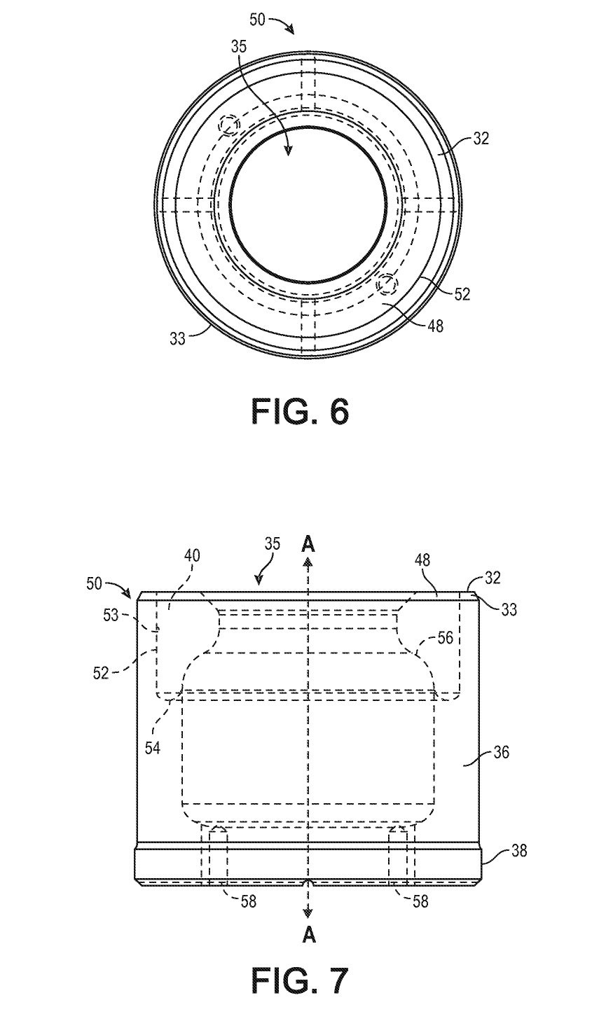

FIGS. 5, 6, and 7 illustrate an embodiment of a thrust ring 50 including and an insert 40 installed into the thrust ring 50. The thrust ring 50 has the insert 40 placed in the insert receiving socket, pocket, or hole 52. The insert 40 has a top surface 48 of the ledge or ring portion 46 where the top surface 48 is substantially contiguous with the upper surface 32 of the body 36. The chamfered surface 33 is located adjacent to the upper surface 32 of the body 36. The insert 40 also has a chamfered surface 51 encompassing the through hole 35. The chamfered surface 51 is similar in dimension and shape to the chamfered surface 34 shown in the embodiment of FIG. 3. As shown in FIGS. 5 through 7, the thrust ring 50, may include the exterior ridge 38. In some embodiments, the thrust ring 50 together with an installed insert 40 has the same or very similar overall dimensions, shape, and size as the thrust ring 22 of FIG. 3.

The body 36 of the thrust ring 50 may also include a side portion 53 of the receiving hole 52 and a bottom or a stop portion 54 of the receiving hole 52 as shown in FIG. 7. In some embodiments, the undersurface 44 of the insert 40 may contact a stop surface 54 of the body 36 when the insert 40 is fully inserted into the insert receiving socket or hole 52. The stop surface 54 may be considered as the bottom of the receiving socket or hole 52. The stop surface 54 may prevent the insert 40 from being pressed too far into the thrust ring 50. The sides 53 of the receiving hole 52 can help secure and locate the insert 40 within the receiving hole 52. The side 53 of the receiving hole 52 and the side surface 42 of the insert 40 may be dimensioned and configured so that when the adapter 40 is fully located in the receiving hole or socket 52, the side 53 of the receiving hole 52 and the side surface 42 to form a contact region such that the upper surface 32 of the thrust ring 50 and the top surface 48 of the insert 40 insert form a contiguous surface.

As best shown in FIGS. 5 and 7, the interior contours 56 of the insert 40 may define a converging and diverging profile as the through hole 35 is initially wide and then narrows at the ring or ledge portion 46 and then widened out again as the interior contours 56 move along axis A-A. The converging and diverging profile may assist in the function of the thrust ring 50.

In some embodiments, the thrust rings 22, 50 may include fastener holes 58 which allow the thrust ring 22, 50 to be secured within the hammer 18.

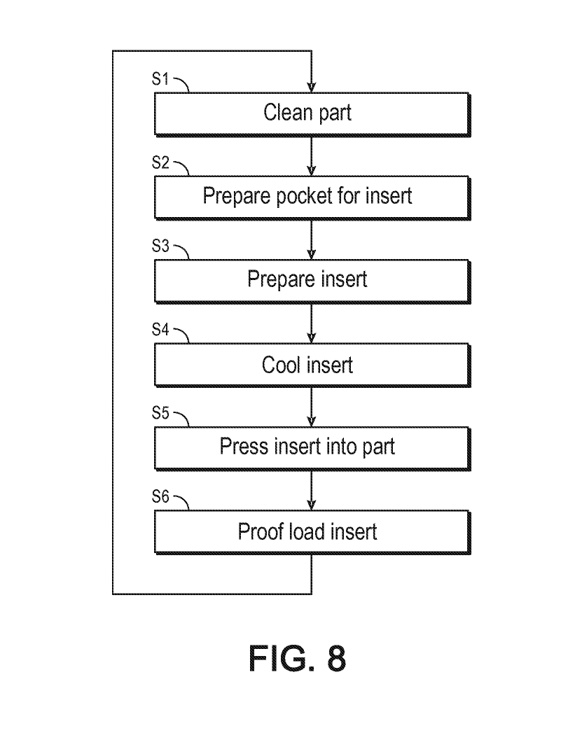

FIG. 8 illustrates a flow diagram of a process that may be used in manufacturing and/or refurbishing a thrust ring 22, 50. FIG. 8 is a flow chart and, as such, does not have reference characters referencing specific machine parts. The reference characters used after specific machine parts are recited in the following text describing the steps of FIG. 8 can be seen in FIGS. 1-7. As shown in step 51, the thrust ring 22, 50 may be cleaned using any suitable cleaner and/or solvent used in the art for cleaning materials such as steel. The cleaning step 51 may be useful when refurbishing worn thrust rings 22, 50 to remove dirt, grease, grime or any other undesired materials located on the thrust ring 22, 50 that may have accumulated during use. In embodiments where the thrust ring 22, 50 is being newly manufactured to include the insert pocket 52, the cleaning of the thrust ring 22, 50 may aid in removing any unwanted debris or other materials that may have accumulated on the thrust ring 22, 50 during its fabrication.

At step S2, the pocket, socket or insert hole 52 is prepared for receiving the insert 40 in the thrust ring 50. In embodiments where a worn thrust ring 22 is being refurbished, preparing the pocket 52 for the insert 40 may include machining the pocket 52 in the thrust ring 22. In embodiments where the thrust ring 50 is being newly manufactured to receive the insert 40, preparing the pocket 52 for the insert 40 may simply include forming the pocket 52. In some instances, preparing the pocket 52 for the insert 40 may also include heating the pocket 52 area of the thrust ring 50 or the entire thrust ring 50 in order to expand the thrust ring 50 so it may more easily receive the insert 40.

At step S3, the insert 40 is prepared for being inserted into the pocket 52. This preparation may include, but is not limited to, cleaning the insert 40 and performing a machining or other operation on the insert 40 to bring the side surface 42 of the insert 40 to a desired dimension.

At step S3, the insert may be cooled prior to being fit into the thrust ring. In some embodiments, the insert 40 may be cooled to a temperature less than negative 30° F. and, in some embodiments, cooled to a temperature of less than negative 40° F. In some embodiments, the insert 40 is cooled to a temperature warmer than negative 100° F. At step S5 the insert is pressed into the receiving hole or socket 52 in the thrust ring 50. As can be appreciated by one of ordinary skill the art after reviewing this disclosure, the insert 40 may be press fit (sometimes referred to as an interference fit) into the thrust ring 50. Cooling the insert 40 may cause the insert 40 to shrink and thereby allowing the insert 40 to more easily be placed into the thrust ring 50. Once the thrust ring 50 and insert 40 warm to typical ambient temperatures, the insert 40 will expand to form even a tighter fit within the thrust ring 50.

Optionally, and as described above, the thrust ring 50 may be heated in order to expand the insert hole or pocket 52 to more easily allow the insert 40 to be placed with in the thrust ring hole or socket 52. Once the thrust ring 50 returns to a more typical ambient temperature, the thrust ring 50 may shrink thereby grip the insert 40 more tightly. Optionally, fasteners, threads, an epoxy, adhesive, or any other suitable bonding agent may also be used to attach the insert 40 to the thrust ring 50.

In some embodiments, once the insert 40 has been fitted into the thrust ring 50, the thrust ring 50 and insert 40 combination may be proof loaded at step S6. The proof loading step S6 may include subjecting the insert 40 and thrust ring 50 combination to greater forces that would normally be anticipated to be placed on the thrust ring 50 and insert 40 combination and inspecting and/or measuring the thrust ring 50 and insert 40 for any displacement or other abnormality. Once the thrust ring 50 and insert 40 have successfully been proof loaded and inspected, the thrust ring 50 and insert 40 combination may be used in a hammer 18 as described above.

In some embodiments, the thrust ring 50 and insert 40 combination may again become worn and be in need of refurbishment. In such an instance, the insert 40 may be removed from the thrust ring 50 and the method set forth in FIG. 8 and described above may be repeated to place a new insert 40 in the thrust ring 50. Removal of the insert 40 from the thrust ring 50 may be accomplished by using any suitable means.

### INDUSTRIAL APPLICABILITY

The apparatus and methods described herein are useful for providing thrust rings for hydraulic hammers. The thrust ring may be provided to the hydraulic hammer when hydraulic hammer is being manufactured or when the hydraulic hammer is undergoing periodic maintenance. Often during periodic maintenance of a hammer, the thrust ring shows signs of wear and needs to be replaced or refurbished. The method and apparatus described herein will provide a method for refurbishing a thrust ring or a source of new or refurbished thrust rings for hydraulic hammers.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

We claim:

1. A thrust ring comprising:
an annularly shaped body defining an interior hole having a diameter;
an annularly shaped insert defining an exterior diameter sized similarly to the interior hole diameter;
a top surface located on the body, the top surface located adjacent to the interior hole;
an insert surface defined by the insert, the insert surface being annularly shaped; and
an interior chamfered surface on the insert intersecting the insert surface.

2. The thrust ring of claim 1, further comprising a contact region where the exterior diameter of the insert contacts the interior hole of the body.

3. The thrust ring of claim 2, wherein the insert is press fit into the body.

4. The thrust ring of claim 3, wherein the top surface and the insert surface are dimensioned and oriented to provide a substantially contagious surface across the contact region.

5. The thrust ring of claim 1, further including an interior ring portion located at an interior portion of the insert.

6. The thrust ring of claim 1, further comprising a stop surface defined by the body and located and oriented to stop the insert from moving further into the body.

7. The thrust ring of claim 1, wherein the body and the insert are made of steel.

8. The thrust ring of claim 7, wherein the body and the insert are made of the same alloy of steel.

9. The thrust ring of claim 1, further comprising a hydraulic hammer containing the thrust ring.

10. The thrust ring of claim 9, further comprising a machine operatively connected to the hammer.

11. An insert for a thrust ring comprising:
an annularly shaped body defining an interior hole having a longitudinal axis;
an insert surface defined by the body and located at one end of the body;
an underside surface located at an opposite end of the body than the insert surface, the underside surface being more narrow than the insert surface;
a ring shaped portion located in an interior of the insert, the ring shaped portion defines a cross-section of the interior hole taken parallel to the longitudinal axis, and the ring shaped portion defines converging and diverging surfaces; and
a chamfered surface located on the insert surface and the chamfered surface encompasses the interior hole.

12. The insert of claim 9, wherein the insert is made of steel.

13. The insert of claim 9, further comprising a chamfered surface intersecting the underside surface.

14. A method of making a thrust ring comprising:
forming an insert pocket, the insert pocket having an interior diameter in an annular body;
forming an annular insert to have an outer diameter slightly larger than the interior diameter of the insert pocket;
cooling the insert; and
pressing the insert into the insert pocket.

15. The method of claim 14, further including cleaning the annular body.

16. The method of claim 14, further including heating the annular body prior to pressing the insert into the insert pocket.

17. The method of claim 14, wherein cooling the insert includes cooling the insert to at least −30 degrees Fahrenheit.

18. The method of claim 14, wherein cooling the insert includes cooling the insert to at least −40 degrees Fahrenheit.

19. The method of claim 14, further comprising proof loading the thrust ring.

20. The method of claim 14, further comprising removing the insert and pressing in a second insert.
